(19) United States
(12) Patent Application Publication
(10) Pub. No.: US 2017/0312989 A9
(43) Pub. Date: Nov. 2, 2017

(54) Friction Stir Processing Tool Having Non-Circumferential Shoulder and Friction Stir Processing Method Performable Therewith

(71) Applicant: EADS Deutschland GmbH, Ottobrunn (DE)

(72) Inventors: Juergen SILVANUS, Unterhaching (DE); Tommy BRUNZEL, Meerane (DE)

(21) Appl. No.: 14/296,125

(22) Filed: Jun. 4, 2014

(30) Foreign Application Priority Data
Jun. 5, 2013 (EP) 13002881.4

(51) Int. Cl. B29C 65/06; B23K 20/12

(52) U.S. Cl. CPC B29C 65/0672; B23K 20/1245; B23K 20/1255

(57) ABSTRACT

A friction stir processing tool for friction stir processing includes a shoulder for pressing against a workpiece surface and a pin, which protrudes beyond the shoulder and can be driven to rotate, for plasticizing introduction into at least one workpiece to be processed. The shoulder has an interruption opening on a circumferential region, so that the shoulder is not led around the entire circumference of the pin.

### CROSS-REFERENCE TO RELATED APPLICATIONS

This application claims priority under 35 U.S.C. §119 to European Patent Application No. 13 002 881.4-1702, filed Jun. 5, 2013, the entire disclosure of which is herein expressly incorporated by reference.

### BACKGROUND AND SUMMARY OF THE INVENTION

Exemplary embodiments of the invention relate to a friction stir processing tool for friction stir processing, having a shoulder for pressing against a workpiece surface and a pin, which protrudes beyond the shoulder and can be driven to rotate, for the plasticizing introduction into at least one workpiece to be processed. Furthermore, the invention relates to a friction stir processing device provided with such a friction stir processing tool. Furthermore, the invention relates to a friction stir processing method performable using such a friction stir processing tool or such a friction stir processing device.

The invention is in the field of friction stir processing, which is applied for repairing, processing, and finishing, and in particular for connecting, workpieces. In the case of friction stir processing, a pin-shaped protrusion is introduced with rotating movement into at least one workpiece to modify the workpiece material at least in the contact region of the welding pin. The rotating pin is introduced into a crack of a workpiece for repair purposes, for example.

A special case of friction stir processing is friction stir welding (FSW), which is increasingly being used in aerospace technology, in rail traffic technology, entertainment electronics, and in automotive engineering. This is a simple, clean, and innovative joining method, which is distinguished by a high efficiency and a high potential for automation, whereby reduction costs are decreased and the weight of structures produced therefrom is reduced.

Friction stir welding is described in PCT document WO 93/10935. In this case, two workpieces to be welded to one another are brought into contact and held in this position. A welding pin or a pin-shaped projection of a corresponding tool is introduced into the connecting region of the workpieces until a shoulder arranged above the pin on the tool rests on the surface of the workpieces. In this case, friction heat is generated by the relative movement between tool and workpieces, so that adjacent material regions in the connecting region assume a plasticized state. While the rotating pin is in contact with the connecting region, the tool is moved forward in the feed direction along a connecting line of the workpieces, so that the material located around the pin plasticizes and subsequently consolidates. Before the material hardens completely, the welding pin is removed from the connecting region or the workpieces.

German patent document DE 10 2005 030 800 B4 discloses a friction stir processing tool, a friction stir processing device provided therewith, and a friction stir processing method in the form of a friction stir welding method for welding at least two workpieces, which lie one on another, along a connecting line by means of friction stir processing. The friction stir welding method known from German patent document DE 10 2005 030 800 B4 is distinguished in that, in contrast to the previously known friction stir welding method, only the pin is driven to rotate during the welding operation, while the shoulder is held at a speed n=0. The shoulder and the pin are therefore implemented as rotatable relative to one another. A variety of difficult welding tasks may thus be performed.

A connection of work pieces of different thicknesses still represents a greater challenge. In particular friction stir welding along a step or an edge offset between the workpieces is anything but trivial.

German patent document DE 100 63 920 A1 discloses applying a pedestal to the edge offset which supports the thinner workpiece and then carrying out the friction stir welding method from the rear side, where the two workpieces lie with their upper outer sides in one plane. Such a welding method may not be carried out in the case of all welding tasks, however; often welding is desirable in particular from the side having the edge offset area; in particular, it is desirable to generate a corresponding flattened or beveled transition instead of the edge offset. However, in particular this is connected to difficulties, as explained in German patent document DE 100 63 920 A1.

To connect two work pieces of different thicknesses having edge offset, German patent documents DE 102 96 452 T5 (German translation of WO 02/070186) and DE 601 08 812 T2 (German translation of EP 1 166 946 B1) disclose a friction stir processing tool having shoulder and pin protruding from the shoulder be applied at an angle of attack in relation to the workpieces to be connected and to be moved at this angle of attack in the feed direction to form the weld seam.

For this purpose, according to German patent document DE 102 96 452 T5, the friction stir processing tool, which rotates as a whole, having shoulder and protruding pin implemented integrally with the shoulder, is to be moved with axis of rotation set diagonally to the surface of the workpieces to be connected in the feed direction over the connecting line. This may be achieved, for example, by means of a robot arm having multiple joints. However, the process control of such a welding method is anything but trivial. The robot must be provided with at least five joints and be guided correspondingly precisely. A complicated friction stir processing device having complicated mount is therefore to be provided for the friction stir processing tool.

In contrast, German patent document DE 601 08 812 T2 discloses supporting the workpieces to be connected on an inclined plane, to thus provide the oblique angle of attack for the tool, which also rotates as a whole. This is also not trivial, since the workpieces must accordingly be mounted in a more difficult manner on the inclined plane.

In general, the shoulder of friction stir processing tools is provided for the purpose of avoiding an escape of plasticized material. The shoulder therefore has a sealing effect, to hold the plasticized material at the welding point. The shoulder is provided in all of the prior art extending around the pin on a circular-cylindrical body, to fulfill this sealing task. The rotational symmetry and the complete circumference of the shoulder in the circumferential direction around the axis of rotation of the pin are absolutely required features according to the prior art to fulfill the function of the shoulder. This applies in particular to shoulders of one-piece rotating friction stir processing tools, which are used for welding at a step or an edge offset of workpieces. In particular the welding at an edge offset still causes difficulties, however. As described in German patent document DE 100 63 920 A1, for example, during the welding of workpieces having edge offset, the upper free edge of the thicker workpiece softens and is pressed flat by the friction surface of the tool—which is provided on the shoulder—to the height of the thinner plate or to form a transition region. However, an undesirable bulge forms adjacent to the tool, in this case. In addition, only small thickness jumps can be compensated for. In the case of greater thickness jumps, a notch effect results at the thickness transition, which is critical with respect to the further processing and which can result in component failure.

Therefore, in previous friction stir welding methods having edge offset, a matching oblique angle of attack must be selected and maintained during the welding operation. This is difficult to handle in processing.

Exemplary embodiments of the present invention are directed to a friction stir processing tool and a friction stir processing device provided therewith, using which in particular—but not exclusively—a friction stir welding of joined parts having edge offset can be carried out while ensuring robust process control, also under varying boundary conditions, but in a simpler manner and with simpler means than heretofore.

The invention, according to one aspect thereof, provides a friction stir processing tool for friction stir processing, having a shoulder for pressing against a workpiece surface and a pin, which protrudes beyond the shoulder and can be driven to rotate, for the plasticizing introduction into at least one workpiece to be processed, wherein the shoulder has an interruption opening on a circumferential region, so that the shoulder is not led around the entirety of the circumference of the pin.

In other words, a friction stir processing tool having non-circumferential shoulder is provided.

The use of a conventional friction stir processing tool of the type shown in German patent document DE 102 96 452 T5 or DE 601 08 812 T2 while using an oblique angle of attack does provide robustness during the welding of joined parts having edge offset, but requires a complex handling technique, in particular during the execution of nonlinear seams. The angle of attack must be tracked particularly when the feed direction changes. Furthermore, the positive effect of the tool angle of attack for increasing the process tolerance against edge offset is limited.

In contrast, another approach is selected in the case of the invention. According to the invention, a shoulder that is circumferential around the entirety of the circumferential direction is not used, but rather the shoulder has an interruption opening on a circumferential region. The pin is preferably not completely enclosed by the shoulder.

As experiments have shown, using a preferred embodiment, an extreme process tolerance against edge offset can be achieved without having to set an angle of attack and having to accept its complications, preferably with use of a nonrotating shoulder by way of an opening of the tool shoulder.

Overall, the process robustness may be increased and the handling technology may be substantially simplified using a friction stir processing tool according to the invention or the advantageous embodiments thereof.

It is preferable for the interruption opening to be implemented in the form of a circular segment viewed in the axial direction in relation to the axis of rotation of the pin.

It is preferable for the friction stir processing tool to be implemented as a friction stir welding tool for connecting two work pieces along a weld seam by friction stir welding.

It is preferable for the pin to be rotatable in relation to the shoulder and/or for the shoulder to be implemented for the purpose of having a speed n=0 with pin rotating in the course of the friction stir processing.

According to a further aspect, the invention provides a friction stir processing device having a friction stir processing tool of the above-mentioned type having non-circumferential shoulder and a tool guide unit for moving and guiding the friction stir processing tool in a feed direction, for example, during seam welding. The friction stir processing device is implemented such that the interruption opening of the shoulder is oriented in the feed direction.

According to a further aspect, the invention provides a friction stir processing method for processing at least one workpiece by means of friction stir processing, comprising the steps of introducing a rotating pin into the at least one workpiece and plasticizing the workpiece material by friction stir processing, preventing an escape of plasticized material by pressing a shoulder, which at least partially encloses the pin, against the surface of the at least one workpiece, wherein a shoulder having an interruption opening is used, which does not completely enclose the pin.

It is preferable for the friction stir processing method to be a friction stir welding method for connecting a first workpiece and a second workpiece by means of friction stir welding.

A preferred embodiment of such a friction stir welding method has the following steps:

moving the pin and the shoulder in a feed direction to form a weld seam,

fixing the shoulder in place during the welding operation with rotating pin having interruption opening oriented in the feed direction, so that the shoulder is moved while not rotating, having interruption opening oriented forward in the feed direction, over the weld seam to be formed.

Furthermore, the following step is preferably provided: welding the first workpiece and the second workpiece along a step or an edge offset between the workpieces.

Experiments have shown that by leaving the heretofore followed path, according to which the shoulder has always necessarily been led around the pin, and rather by providing a shoulder, which is provided partially on the circumference with an interruption opening, better welding can be achieved in the region of edge offsets of workpieces. The sealing task of the shoulder may be achieved in the region of the interruption opening by the upwardly protruding edge.

For this purpose, during the performance of a friction stir welding method, the interruption opening is preferably oriented forward in the feed direction, so that the edge is guided through the interruption opening to the rotating pin in the friction stir processing tool. The edge is plasticized therein by the friction heat generated by the rotation of the pin. The material of the edge that is not yet plasticized ensures that the already plasticized material does not exit at the interruption opening. The shoulder is preferably embodied such that the shoulder completely encloses the pin at the remaining regions. For example, the shoulder is open on a segment of the overall circumference at an angle range of 0° to 90°, preferably at an angle range of approximately 5° to 45°. The shoulder is still provided on the remaining region of the entire circumference.

The shoulder is preferably held stationary in relation to the workpieces to be processed, so that it does not co-rotate with the pin. For this purpose, the measures can be taken as described and shown in German patent document DE 10 2005 030 800 B4. In one embodiment, the shoulder can be placed via a bearing on a rotating body, which is driven to rotate and has the pin. Such a shoulder is held stationary by the placement on the workpieces, also when the pin is driven to rotate. If the friction stir processing tool is pushed forward in the feed direction, the interruption opening can follow the edge profile.

In another embodiment, the shoulder is mounted separately from the pin on a separate mount. This mount can also be implemented as rotatable in a controlled manner, to thus adapt the alignment of the shoulder to a change of the feed direction.

On the other hand, the shoulder does not necessarily have to be implemented as stationary; it could also be mounted to oscillate back and forth in angular ranges, to thus generate additional friction heat if needed. For this purpose, for example, an arrangement similar to FIG. 3 of German patent document EP 1 021 270 B1 could be used, with the modification that the shoulder has an interruption opening—for example, correspondingly extending up to the pin—on a partial region of the circumference.

Advantageous fields of application of the invention comprise connecting work pieces of different thicknesses, for example, connecting plates of different thicknesses, such as tailored blanks.

### BRIEF DESCRIPTION OF THE DRAWING FIGURES

Exemplary embodiments of the invention will be explained in greater detail hereafter on the basis of the drawings. In the figures:

FIG. 1 shows a first workpiece and a second workpiece, which press against one another with an edge offset and are to be connected to one another in the region of the edge offset by a friction stir processing method;

FIG. 2 shows a side view of an embodiment of a friction stir processing tool for carrying out the friction stir processing method;

FIG. 3 shows a top view of the tool from FIG. 2;

FIG. 4 shows a schematic, very simplified illustration of an embodiment of a friction stir processing tool; and

FIG. 5 shows a schematic sketch, which outlines a performance of a friction stir welding method for welding the two workpieces shown in FIG. 1 by means of the friction stir processing tool shown in FIGS. 2 and 3.

### DETAILED DESCRIPTION

FIG. 1 shows a first workpiece 10 and a second workpiece 12, which are laid adjacent to one another in a butt joint and are to be welded to one another. The first workpiece 10 is thicker than the second workpiece 12. An edge offset 18 thus results on a workpiece surface 14 in the region of the butt joint 16, which is provided in the form of a step 20 when the workpieces 10, 12 are not yet welded.

The two workpieces 10, 12 are to be connected to one another in the region of the butt joint 16 by means of a friction stir welding method.

FIG. 2 shows for this purpose an exemplary embodiment of a friction stir processing tool 30 for friction stir processing, wherein the friction stir processing tool 30 has a pin 32 (also called a probe, welding pin, or welding probe), which can be driven to rotate, and which protrudes from a shoulder 34 in the axial direction when viewed with respect to an axis of rotation 36 of the pin 32.

The shoulder 34 is implemented on a body 38 of the friction stir processing tool 30. The body 38 is preferably implemented as rotatable in relation to the pin 32.

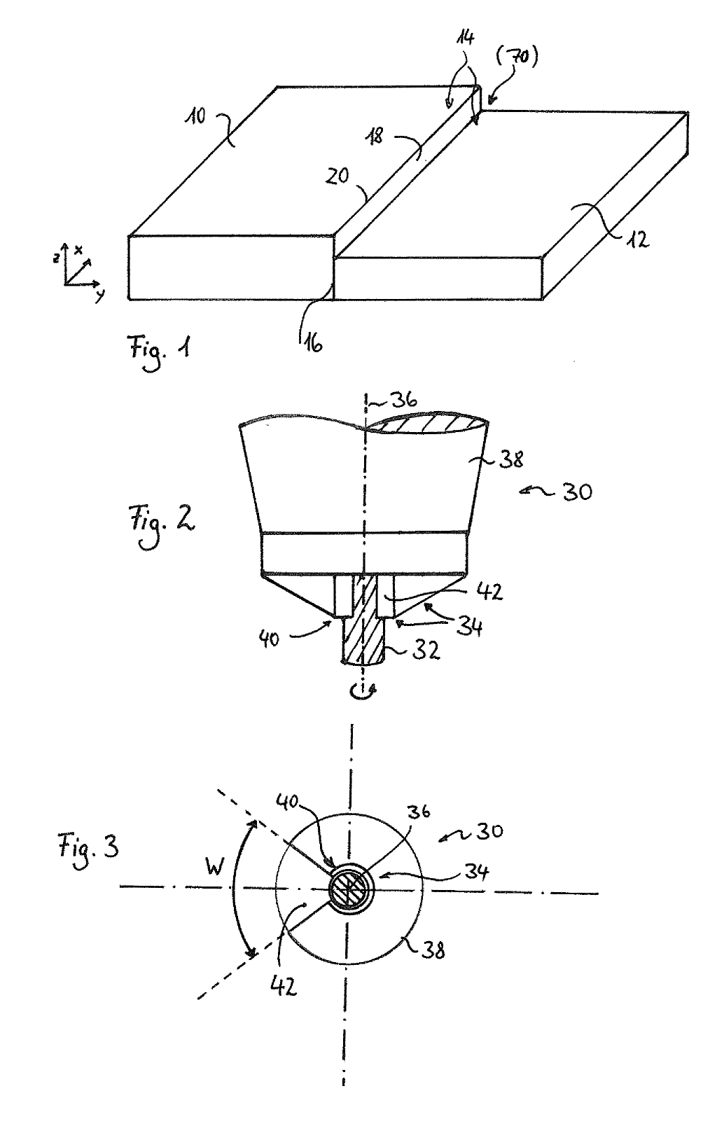

FIG. 3 shows a view of the friction stir processing tool 30 in a comparable implementation to that of FIG. 2, viewed in the axial direction from the bottom in FIG. 2.

As shown in FIGS. 2 and 3, the shoulder 34 is not led around the entirety of the circumference of the pin 32 in the circumferential direction, but rather the shoulder 34 has, in the engagement region 40, which is implemented for the friction attack on the workpieces 10, 12, an interruption opening 42. The interruption opening 42 extends from the external circumference of the shoulder 34 in the engagement region 40 continuously up to the pin 32.

The interruption opening 42 is implemented like a circular segment, in particular viewed in a top view in the axial direction (see FIG. 3) and opens at an angle W, which is preferably implemented as an acute angle in the range of 0° to 90°. The angle W is particularly preferably less than approximately 45° and more preferably less than 20°. The opening angle W and the extension of the interruption opening 42 in the axial direction can be implemented differently depending on the welding task.

The body 38 having the shoulder 34 is rotatable in relation to the pin 32. In particular, the body 38 having the shoulder 34 is implemented such that it does not rotate during the friction stir processing, but rather has a speed n=0. For example, the friction stir processing tool 30 is implemented as disclosed in German patent document DE 10 2005 030 800 B4 with respect to the relative mobility of the pin 32 and the body 38.

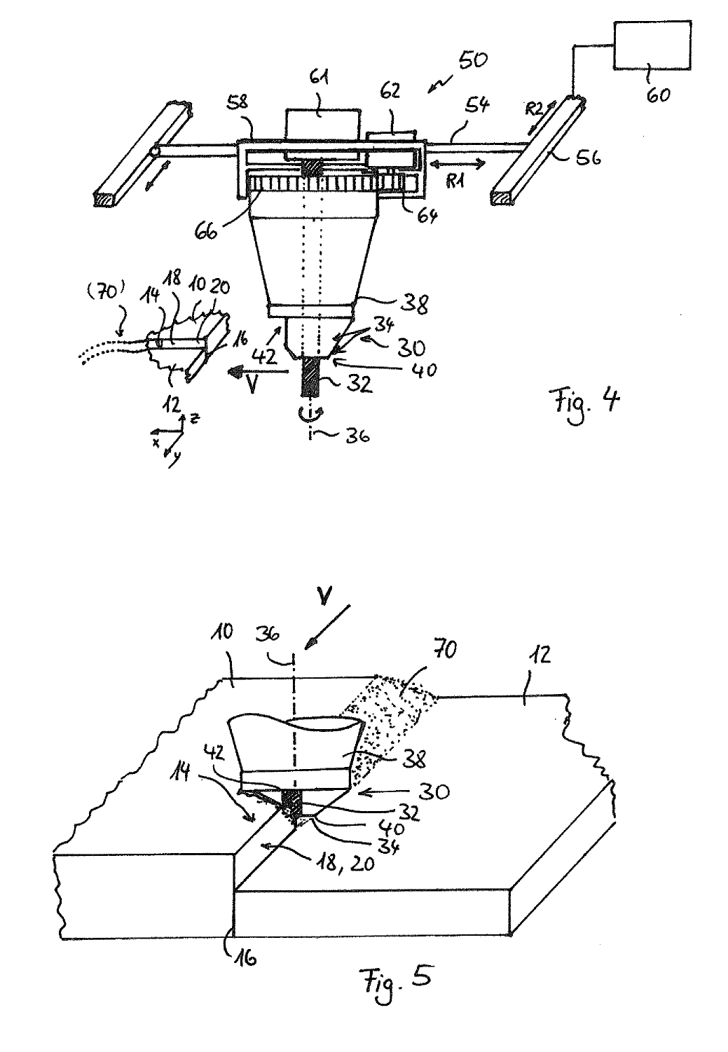

FIG. 4 shows an example of a friction stir processing device 50 for friction stir processing, which has the friction stir processing tool 30 having the interruption opening 42 on the shoulder 34 and a tool moving unit 52 for moving and guiding the friction stir processing tool 30.

The tool moving unit 52 is implemented for moving and guiding the friction stir processing tool 30 in various directions. For this purpose, in the example shown in FIG. 4, which outlines a simple embodiment of the tool moving unit 52, a first guide unit 54 for moving the friction stir processing tool 30 in a first direction R1 (for example, the X direction) and a second guide unit 56 for moving the friction stir processing tool 30 in a second direction R2 (for example, the Y direction) are provided. Of course, a third guide unit (not shown) for moving the friction stir processing tool 30 in a third direction (for example, the vertical direction, the Z direction) can also be provided.

The friction stir processing device 50 furthermore has a frame 58 or a housing, which is to be moved by means of the tool guide unit 52, controlled via a controller 60, in the respective direction for performing the desired friction stir process.

A first rotary drive 61 for rotating the pin 32 is provided on the frame 58 (or the housing).

In the exemplary embodiment of the friction stir processing device 50 shown here, furthermore a pivot drive 62, which is controlled by the controller 60, is provided on the frame 58 (or the housing), by means of which the body 38 having the shoulder 34 is movable into an arbitrary angle alignment, where the body 38 is then held stationary. The pivot drive 62 is connected, for example, via a gear wheel 64 and a gear ring 66 to the body 38. For example, the pivot drive 62 has a stepping motor.

The controller 60 is preferably implemented such that friction stir welding for connecting the first workpiece 10 and the second workpiece 12 can be carried out using the friction stir processing device 50. For this purpose, the pin 32 is driven to rotate using the rotary drive 61 and introduced into the region of the butt joint 16 (or another connecting region) of the workpieces 10, 12. The materials of the workpieces 10, 12 are plasticized by the friction heat between pin 32 and the workpieces 10, 12. For the friction stir processing, the friction stir processing tool 30 is then moved in a feed direction V, controlled via the controller 60. The shoulder 34 is aligned in this case by the pivot drive 62 such that the interruption opening 42 always points in the feed direction V.

The alignment of the interruption opening 42 can be varied by the pivot drive 62 in accordance with the profile of the butt joint 16 and depending on a corresponding change of the feed direction V. This is indicated in FIG. 4 by a curved profile of the butt joint 16 and the edge offset 18 by dotted lines; along this curved profile, a curved weld seam 70 can thus also be formed.

FIG. 5 shows a very schematic illustration of the friction stir processing tool 30 in the course of the friction stir welding in the attack on the first workpiece 10 and the second workpiece 12.

Heretofore, it has always been presumed that shoulders of friction stir processing tools must be led around the entire circumference of the pin 32, so that they can fulfill their task of holding back plasticized material at the welding point. As shown in FIG. 5, in the case of the not fully-circumferential shoulder 34, the interruption opening 42 is provided; however, the edge offset 18 of the still un-welded workpieces 10, 12 fulfills the task of holding back the plasticized material here.

Experiments have shown that using such a friction stir processing tool 30 having not fully-circumferential shoulder 34, friction stir processing of workpieces 10, 12 having edge offset 18 can be carried out with greater process reliability, without an oblique angle of attack of the friction stir processing tool 30 having to be set. Such an oblique angle of attack is difficult to handle, in particular with a curved profile of the weld seam 70, as indicated by dotted lines in FIG. 4.

Various embodiments of the friction stir processing tool 30 and the friction stir processing device 50 are possible. The shape of the interruption opening 42 can thus deviate from the illustrated shape.

Instead of the simple version of the tool moving unit 52 indicated in FIG. 4, a robot arm can also be provided as the tool moving unit 52—as is well-known—on the end of which the frame 58 or the housing having the rotary drive 61 is to be provided. The pivot drive 62 can be formed, for example, by a corresponding pivot capability of the tool attachment of the robot arm.

Although the friction stir processing tool 30 and the friction stir processing device 50 were shown and described for use as a friction stir welding tool for connecting workpieces 10, 12 along a weld seam or as a friction stir welding device for connecting the workpieces 10, 12 along the weld seam, respectively, the possible uses of the friction stir processing tool 30 and the friction stir processing device 50 are not restricted to this application. Other friction stir processing tasks, for example, smoothing an edge offset 18 on a one-piece workpiece (not shown) or repairing a workpiece in the region of an edge offset or the like can also be carried out.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

### List of Reference Numerals

10 first workpiece
12 second workpiece
14 workpiece surface
16 butt joint
18 edge offset
20 step
30 friction stir processing tool
32 pin
34 shoulder
36 axis of rotation
38 body
40 engagement region
42 interruption opening
50 friction stir processing device
52 tool moving unit
54 first guide unit
56 second guide unit
58 frame
60 controller
61 rotary drive
62 pivot drive
64 gear wheel
66 gear ring
70 weld seam
W opening angle
R1 first direction
R2 third direction
V feed direction

What is claimed is:

1. A friction stir processing tool for friction stir processing, comprising:
a shoulder configured to press against a workpiece surface; and
a pin, which protrudes beyond the shoulder and which is rotatable, configured for plasticizing introduction into at least one workpiece to be processed,
wherein the shoulder of the friction stir processing tool has an interruption opening on a circumferential region, so that the shoulder is not led around an entire circumference of the pin.

2. The friction stir processing tool of claim 1, wherein the interruption opening is in a form of a circular segment when viewed in an axial direction in relation to an axis of rotation of the pin.

3. The friction stir processing tool of claim 1, wherein the friction stir processing tool is configured as a friction stir welding tool for connecting two workpieces along a weld seam by friction stir welding.

4. The friction stir processing tool of claim 1, wherein the pin is rotatable in relation to the shoulder or the shoulder is implemented to have a speed n =0 with pin rotating during the friction stir processing.

5. A friction stir processing device, comprising
a friction stir processing tool, which comprises
a shoulder configured to press against a workpiece surface; and
a pin, which protrudes beyond the shoulder and which is rotatable, configured for plasticizing introduction into at least one workpiece to be processed,
wherein the shoulder of the friction stir processing tool has an interruption opening on a circumferential region, so that the shoulder is not led around an entire circumference of the pin, and
a tool guide unit configured to move and guide the friction stir processing tool in a feed direction during seam welding, wherein the interruption opening is oriented in the feed direction.

6. A friction stir processing method for processing at least one workpiece by friction stir processing, comprising the following steps:
introducing a rotating pin into the at least one workpiece and plasticizing the workpiece material by friction stir processing,
preventing an escape of plasticized material by pressing a shoulder enclosing the pin against the surface of the at least one workpiece, wherein a shoulder has an interruption opening and does not completely enclose the pin.

7. The friction stir processing method of claim 6, wherein the friction stir welding method connects a first and a second workpiece by friction stir welding.

8. The friction stir processing method of claim 7, further comprising:
forming a weld seam by moving the pin and the shoulder in a feed direction to form a weld seam; and
holding the shoulder stationary during the welding operation with rotating pin, with interruption opening oriented in the feed direction, so that the shoulder is moved over the weld seam to be formed in a nonrotating manner with interruption opening oriented forward in the feed direction.

9. The friction stir processing method of claim 7, further comprising:
welding the first workpiece and the second workpiece along a step or an edge offset between the workpieces.
